(19) United States
(12) Patent Application Publication
(10) Pub. No.: US 2018/0025459 A1
(43) Pub. Date: Jan. 25, 2018

(54) METHOD AND SYSTEM FOR COLLECTING SUPPLIER PERFORMANCE DATA AND IDENTIFYING STATISTICALLY-SIGNIFICANT PERFORMANCE EVENTS ACROSS A PLURALITY OF CUSTOMER BUSINESSES

(71) Applicant: Henry Matthew Shapiro, Summerville, SC (US)

(72) Inventor: Henry Matthew Shapiro, Summerville, SC (US)

(73) Assignee: Dipmoe, LLC, Summerville, SC (US)

(21) Appl. No.: 15/218,033

(22) Filed: Jul. 24, 2016

(51) Int. Cl. G06Q 50/28; G06Q 30/02

(52) U.S. Cl. CPC G06Q 50/28; G06Q 30/0282

(57) ABSTRACT

A method and system for the collection of supplier performance data and the identification of out-of-control conditions, shifts, and trends. Supplier performance data is collected by a plurality of businesses (customer businesses) on an electronic business network using a centralized web application and server. Once the web application saves the supplier performance data, computer code on the server statistically analyzes the data to identify statistically significant out-of-control conditions, shifts, and trends. If the computer code identifies an out-of-control condition, shift, or trend in a supplier's performance, the computer code notifies all of said supplier's customers within the electronic business network. The present invention increases supply chain visibility beyond a single customer business thereby improving supply chain performance and reducing supply chain risk.

### TECHNICAL FIELD

The present invention relates to organizational supply chain management.

### BACKGROUND OF THE INVENTION

Businesses, herein referred to as customer businesses, spend a lot of money procuring products and services from external suppliers. For example, in the manufacturing industry, it is typical for 50% or more of cost of goods sold (COGS) to comprise products and services provided by external suppliers. Because of the lack of direct control a customer business has over its suppliers' internal processes and the large amount of money it spends on external products and services, a high risk exists that the customer business' performance will be negatively and significantly impacted by poor performance in its supply chain. If a supplier delivers late, delivers bad product, or delivers over budget, the customer business' own cost, schedule, and quality performance can be affected; its customer relationships can suffer; its profitability can decrease; and ultimately, its survivability can be threatened.

To solve this problem, customer businesses focus on two specific areas of the supply chain. The first focus area involves mitigating supplier performance risk up front when selecting a new supplier. If an organization can identify a good supplier from the start, its overall supply chain risk decreases while supply chain performance improves. Various methods are used to identify and select good suppliers up front including but not limited to the requirement for industry certifications, review of proposals, conducting of site visits and audits, review of organizational supplier applications, consideration of referrals and recommendations, and review of 3^{rd}-party financial data. These methods leave a critical gap in supply chain visibility. The problem is that these methods do not give a customer organization objective insight into a supplier's past performance on cost, schedule, or quality. Without that insight into past performance, customer businesses frequently choose suppliers that meet all initial requirements, but have a poor history of cost, schedule, and quality performance. The result is a weakened, more risky supply chain for the customer business.

The second supply chain area customer businesses focus on when managing supplier risk is the performance of their existing suppliers. Many customer businesses collect and analyze supplier performance metrics focused on cost, schedule and quality. Some use objective, event-driven data, while others rely on internal surveys with subjective rating criteria. They frequently set performance goals for key suppliers and use the collected data to identify strong and weak performers. With this stratification, customer businesses are able to make critical decisions regarding which suppliers to help improve, which to remove from their approved suppliers lists, which to give less work to, and which to give more work to. The problem with this solution is that the described data does not give the full picture of a single supplier's performance. As the customer organization can only collect and analyze supplier performance data for goods and services supplied directly to them by their own suppliers, a second critical gap in supply chain visibility emerges: How are the customer businesses' suppliers performing for other organizations? Without this supply chain visibility, a customer business is blind to external indicators of change in supplier performance, positive or negative, that it could use to make more objective, better informed supply chain decisions. This lack of complete supply chain visibility could result in an improving supplier being removed from the approved suppliers list or having its workload reduced while a declining supplier is given more work.

Accordingly, there is a need for a method and system for identifying out-of-control conditions, trends, and shifts for supplier performance that objectively takes into account a supplier's cost, schedule, and quality performance across a plurality of customer businesses, without limitation to data collected by only a single customer business.

### SUMMARY OF THE INVENTION AND ADVANTAGES

The subject invention comprises a method and system to identify out-of-control conditions, trends, and shifts for a supplier's performance across an electronic business network of suppliers and customer businesses herein referred to as electronic business network. Using a centralized web application, the electronic business network's customer businesses collects a set of standard, objective, crowd-sourced cost, schedule, and quality supplier performance metrics. The metrics are recorded to a server that mathematically analyzes the data against the supplier's complete performance dataset for all of the supplier's customers thereby identifying statistically-significant, short-term indicators of risk as well as long-term trends and process shifts. The server then notifies all of the supplier's customers in the electronic business network of the identified out-of-control condition, trend, or process shift. This method overcomes the deficiencies of the existing solutions by providing increased supply chain visibility for customer businesses when sourcing new suppliers as well as when managing the risk and performance of their existing, approved suppliers. This method gives customer businesses greater insight into supplier performance and enables smarter, objective supply chain decisions resulting in lower risk and better performance.

### BRIEF DESCRIPTION OF THE DRAWINGS

FIG. 1 is a flow diagram depicting steps to identify out-of-control conditions, shifts, and trends in supplier performance.

FIG. 2 is a diagram depicting a user interface of the web application for one example embodiment of the present invention.

FIG. 3 is a diagram depicting the system interaction between a supplier, customer businesses, and the web application/server.

FIG. 4 is a diagram depicting how a single delivery triggers supplier performance notifications.

FIG. 5 is a table depicting a set of standard supplier performance metrics for one example embodiment of the present invention.

FIG. 6 is a table depicting a supplier's complete performance dataset for one example embodiment of the present invention.

### DETAILED DESCRIPTION OF THE DRAWINGS

The Brief Summary and Abstract are incorporated here by reference. The method and system comprises collecting supplier performance data, identifying out-of-control conditions, shifts, and trends, and making the performance data available to all affected customer businesses. Customer businesses that receive goods and services from suppliers as members of an electronic business network collect a standard set of supplier performance metrics using a centralized web application on a centralized server. The standardization of the supplier performance metrics is critical for meaningful, collective analysis of data provided by a plurality of customer businesses. A lack in standardization of the metrics would prohibit meaningful statistical analysis of a supplier's complete dataset, which includes all data collected by all of the supplier's customer businesses in the electronic business network. Once the data is collected, the web application saves the data to a database on the centralized server. Computer code on the server then statistically analyzes the data for indicators of out-of-control conditions, shifts, and trends. If an out-of-control condition, shift, or trend in a supplier's performance is identified, the centralized server notifies all of said supplier's customer businesses in the electronic business network of said out-of-control condition, shift, or trend.

Until the present invention, there was no recognition in the art to managing supplier risk and performance by collecting data across a plurality of customer businesses to identify out-of-control conditions, shifts, and trends in a supplier's performance. Instead, prior art focuses on methods to manage supplier risk and performance by collecting and analyzing supplier performance data using data collected by only a single customer business or enterprise with no visibility of risk indicators outside of said customer business. The present inventor is the first to identify a method to increase supply chain visibility beyond that of only a single customer business.

The present invention affords customer businesses two significant improvements and advantages in supply chain management. The first advantage involves how a customer business chooses a new supplier to provide a product or service. The present invention provides said customer business access to past supplier performance data that the customer business may use as an input to the supplier selection process. Using said data, said customer business is able to make a better-informed, objective sourcing decision that reduces overall supply chain risk and improves overall supply chain performance.

The second advantage that the present invention affords a customer business is notification of supplier performance indicators, both positive and negative, identified through analysis that includes an existing supplier's performance for businesses other than said customer business. Using only supplier performance data collected by a single customer business, analysis by said customer business may falsely indicate an out-of-control condition, shift, or trend as compared to results of analysis including data from a plurality of customer businesses that would provide more accurate indicators more consistently as a result of the larger performance dataset being analyzed. These false indicators could influence a customer business to make supply chain decisions that negatively impact their overall supply chain performance and increase supply chain risk.

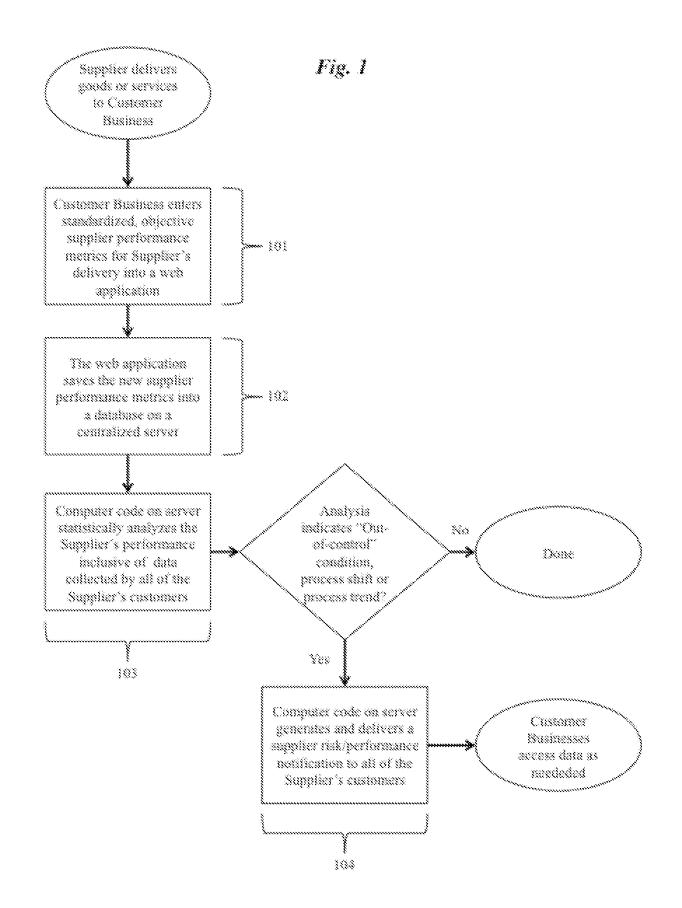

FIG. 1 is a flow diagram depicting the method and system of how to collect supplier performance data and identify out-of-control conditions, shifts, and trends across a plurality of customer businesses. It includes a supplier delivery as entry criteria, measurement of supplier performance data 101, saving of the data 102, analyzing the data 103, notifying supplier customers 104, and customer businesses accessing the performance data as exist criteria. In one example embodiment of the present invention, a supplier and customer business enter into a contractual agreement for the delivery of a set quantity of product. Based on the supplier's performance against the terms in the contractual agreement, the customer business is able to quantify and measure the supplier's performance. The customer business uses an internet-based web application to record a standard, objective set of cost, schedule, and quality data for each supplier delivery made per the contractual agreement. Each time the customer business enters the supplier performance data, the data is saved to a database on a centralized server. This data is then included in the supplier's complete performance dataset inclusive of all data entered by all customer businesses and provides the basis for making statistically-significant conclusions about the larger electronic business-network supply chain. Code on the centralized server then statistically analyzes the supplier's complete performance dataset including the new data entered by the single customer business in order to determine if the new data indicates an out-of-control condition, shift, or trend in the supplier's performance. If so, said code on the server notifies not only the single customer business that entered the supplier's most-recent performance data, but all of the supplier's customers in the electronic business network of the out-of-control condition, shift, or trend in the supplier's performance. All of the supplier's customer businesses in the electronic business network would then be able to make objective decisions about how to mitigate supply chain risk given the data entered by the single customer business.

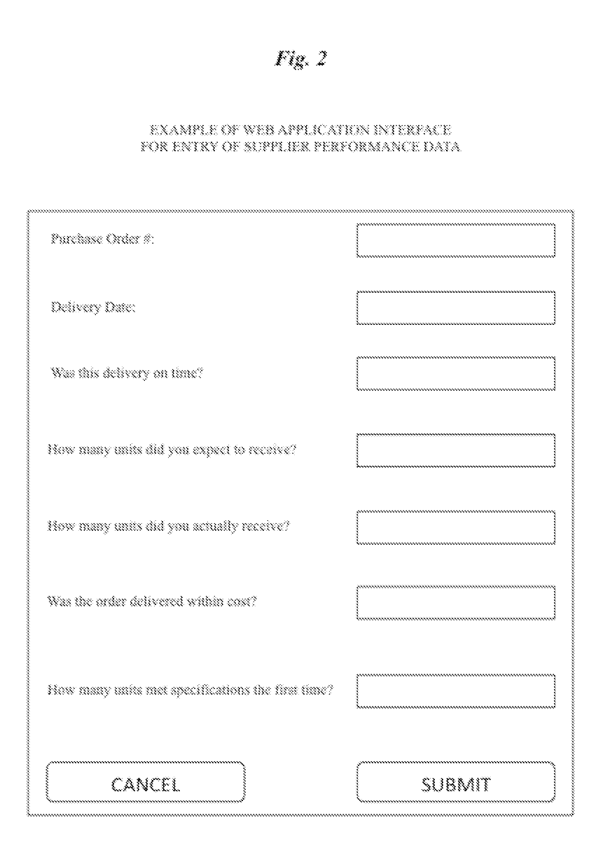

FIG. 2 is a diagram depicting a user interface of the web application for one example embodiment of the present invention. The web application prompts users for entry of the supplier performance data. In this example, the web application prompts the user using specific questions, the answers of which are objective and quantifiable and form the basis for systemic statistical analysis. In another example embodiment, the web application could prompt customer businesses for supplier performance data by listing specific metrics with corresponding html inputs that the customer business would enter calculated metrics into. Though these example user interfaces are provided, it is understood that the present invention could use various interfaces with various prompts for supplier performance data.

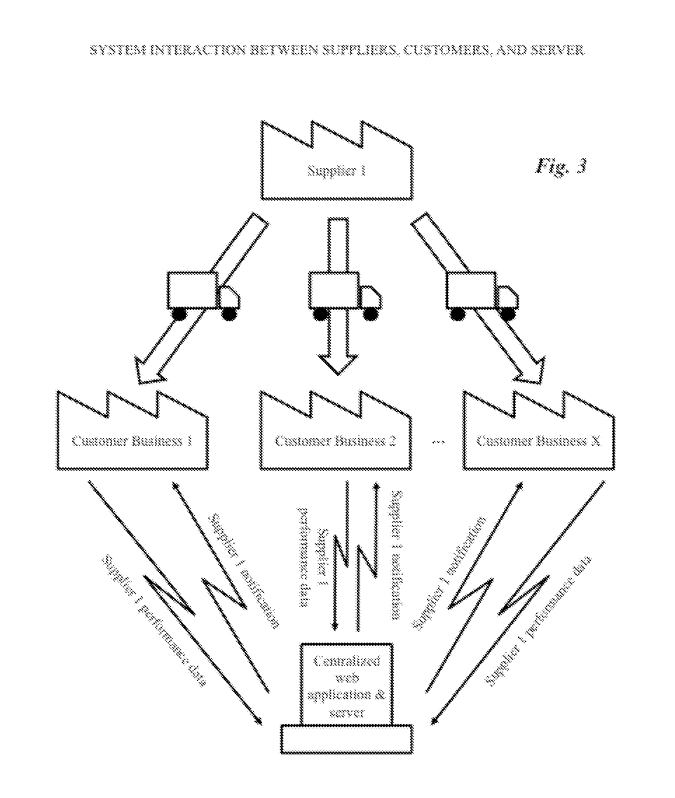

FIG. 3 is a diagram illustrating the system interaction of suppliers, customer businesses, and the web application/server. It depicts a supplier making multiple deliveries to multiple customer businesses. It also depicts the supplier performance data flowing from the customer businesses to the web application/server and supplier performance notifications flowing from the web application/server to the customer businesses in the electronic business network.

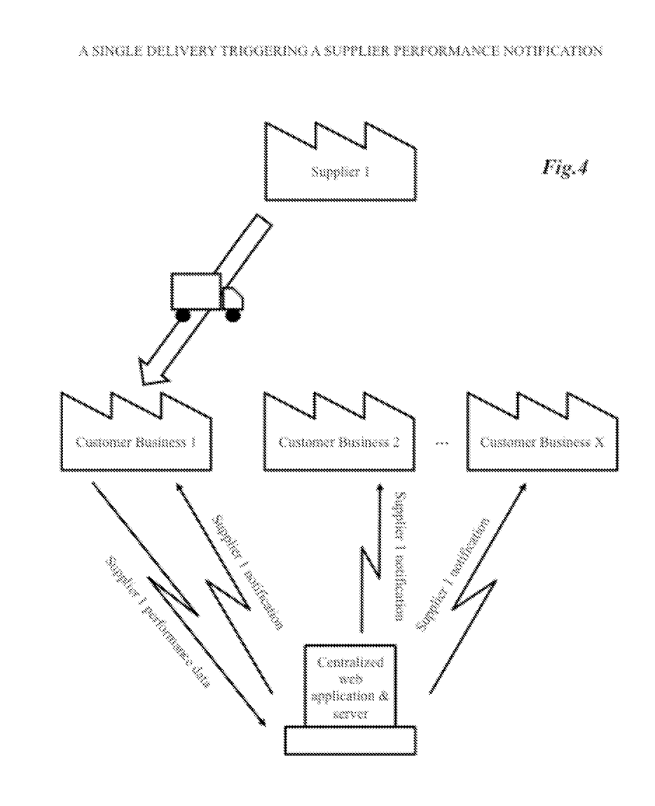

FIG. 4 is a diagram illustrating how a delivery triggers supplier performance notifications. It depicts a single delivery from a supplier to a single customer business that results in a supplier performance notification being generated and delivered to all of the supplier's customers in the electronic business network.

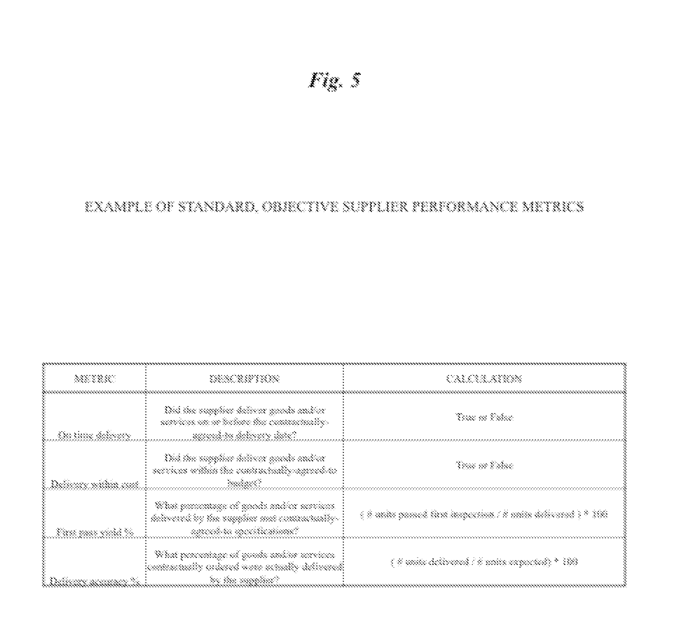

FIG. 5 is a table depicting a set of standard supplier performance metrics for one example embodiment of the present invention. The example set of objective metrics includes description and calculations for on-time delivery, delivery within cost, first-pass yield, and delivery accuracy. Though this example set of metrics is provided, it is understood that the present invention could use any standard set of metrics aligned with supplier cost, schedule, and quality performance and is not constrained to the example set.

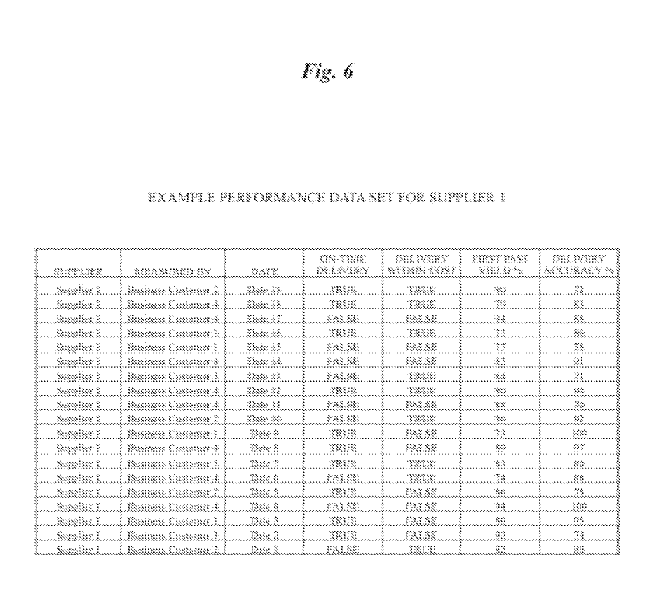

FIG. 6 is a table depicting the supplier performance dataset for a single supplier that would be stored on the centralized server for one example embodiment of the present invention. Columns include Supplier, Measured By which stores the customer business that took the measurement, Date with placeholders substituted in place of actual dates, On-Time Delivery, Delivery Within Cost, First-Pass Yield, and Delivery Accuracy %. The table depicts multiple data points collected by a plurality of customer businesses all of which would be used collectively during statistical analysis to identify out-of-control conditions, shifts, and trends in the single supplier's performance.

While example embodiments of the invention have been illustrated and described, various modifications and combinations can be made without departing from the spirit and scope of the invention. For example, various supplier performance metrics could be used in the standard set, the web application user interface and prompts can vary from provided examples, and the statistical analysis techniques can vary within industry best practices. Modifications, combinations, and equivalents to the system and method of the present invention are intended to be covered and claimed.

What is claimed is:

1) A method and system for collecting supplier performance data and identifying statistically-significant out-of-control conditions, shifts, and trends comprising: an electronic business network including suppliers and the customer businesses said suppliers supply goods and services to; a web application that said customer businesses input supplier performance data in; a database on a centralized server that said web application saves said supplier performance data to; computer code on said server that statistically analyzes said supplier performance data to identify out-of-control-conditions, shifts, and trends and generates notifications of said out-of-control conditions, shifts, and trends to all customers of said supplier in said business network.

2) The method and system of claim 1 wherein suppliers are businesses that provide goods and/or services.

3) The method and system of claim 1 wherein customer businesses are businesses that receive goods and/or services.

4) The method and system of claim 1 wherein the web application prompts the customer business for entry of supplier performance data.

5) The method and system of claim 1 wherein supplier performance data includes objective measures of supplier cost, schedule, and quality performance.

6) The method and system of claim 1 wherein the collected supplier performance data is accessible by the plurality of customer businesses in the internet-based business network.

7) The method and system of claim 1 wherein the statistical analysis of supplier performance data is inclusive of all data entered for a single supplier by a plurality of said supplier's customers.
